(19) United States
(12) Patent Application Publication
(10) Pub. No.: US 2012/0055308 A1
(43) Pub. Date: Mar. 8, 2012

(54) GUIDE FENCE AND CUTTING MACHINE HAVING THE SAME

(75) Inventors: Tomoyuki OTA, Anjo-shi (JP); Mitsuyoshi NIINOMI, Anjo-shi (JP); Syuji AOYAMA, Anjo-shi (JP)

(73) Assignee: MAKITA CORPORATION, ANJO-SHI (JP)

(21) Appl. No.: 13/222,670

(22) Filed: Aug. 31, 2011

(30) Foreign Application Priority Data
Sep. 7, 2010 (JP) 2010-200139

(51) Int. Cl. B23D 47/04; B27B 27/00; B23D 45/04

(52) U.S. Cl. 83/448; 83/471.2

(57) ABSTRACT

A front part of a guide section is made to be a detachable separate sub fence having a guide face, a face of the guide section to which the sub fence is fitted, is made to be a second guide face in parallel with the guide face rising from the top face of a table. The second guide face is in a plane in the rear of the guide face.

### BACKGROUND OF THE INVENTION

This application claims the benefit of Japanese Patent Application Number 2010-200139 filed on Sep. 7, 2010, the entirety of which is incorporated by reference.

### TECHNICAL FIELD

The present invention relates to a cutting machine that holds on a table a main body, which is provided with a rotationally-driving saw blade, in such a manner that the main body is vertically movable to cut with the saw blade a workpiece positioned on the table by lowering the main body. It also relates to a guide fence for use in positioning the workpiece on the table of the cutting machine.

### BACKGROUND ART

A flip-over saw, an example of a cutting machine, horizontally holds a table on a base in such a manner that the table can be flipped over 180° on its central part so that the table can be fixed with either of both sides up. The base is in the shape of a rectangular workbench. On one side of the table, the flip-over saw holds a main body provided with a saw blade which is rotationally driven by a motor. The main body moves vertically so that the saw can be used as a miter saw (a bench-circular saw machine) for cutting a workpiece placed on the table. Cutting of the workpiece is performed by lowering of the main body at the first rotational position of the table where the main body is on the upper side. Further, on the table, a guide fence is provided for positioning the workpiece, wherein the workpiece is pushed against a guide face on front of the guide fence in the lateral direction.

On the other hand, when the main body is fixed on the table at the bottom dead center where the saw blade penetrates the table to protrude downward from the table. With that state, the table is flipped over into the second rotational position where the main body is on the lower side. The saw can be used as a table saw for cutting a workpiece by sliding the workpiece against the saw blade which protrudes from the table.

In a flip-over saw like this, a saw blade penetrates a table to protrude downward, when a main body is lowered down to the bottom dead center in the state as a miter saw. In this state, the penetration length of the saw blade on the table is a cuttable range. To cut a workpiece whose width is beyond a cuttable range, Japanese Patent Application Laid-Open Publication No. 2006-44068, for example, discloses an invention of a guide fence. In the conventional guide fence, a guide face of the guide fence is composed of two vertically separated faces, a first-guide face in the upper part, and a second-guide face in the lower part. The second guide face is in the position retreating from the first-guide face by a predetermined distance and in parallel with the first-guide face. A sub fence is detachably mounted in front of the second-guide face. The sub fence has a sub-guide face on its front and the sub-guide face is flush with the first-guide face when the sub fence is mounted.

The guide fence disclosed in the above-mentioned patent publication, however, results in forming a recess in the lower part of the guide face. Thus, a workpiece having substantially the same height as that of the sub fence may be caught in the recess when the sub fence is detached. Thus, usability is impaired in that the workpiece is extracted from the recess to reset or is unable to be fixed, which may cause damages to a workpiece.

The guide fence disclosed in the above patent publication has another problem. When a bevel cutting is performed by tilting of a saw blade with respect to the upper face of a table, for example, an adjusting block is sometimes used for a guide face near the saw blade. In such a case, the recess of the guide fence may prevent the adjusting block to be fixed.

It is an object of the present invention to provide a guide fence and a cutting machine having the guide fence for cutting a workpiece even whose width is beyond a cuttable range by removal of a sub fence. Further, another object is to surely position a workpiece without any damages when a sub fence is removed. In addition, to use an adjusting block with ease is another object.

### SUMMARY OF THE INVENTION

To achieve the foregoing objects, according to a first aspect of the present invention, a guide fence is provided on a table of a cutting machine, the guide fence including,

a laterally-extending guide section rising from a top face of the table and having a guide face for positioning a workpiece on front of the guide fence, a separate sub fence detachably disposed in a front part of the guide section and having the guide face, and a second guide face provided on a face of the guide section to which the sub fence is to be fitted, being parallel with and in rear of the guide face.

In the configuration of the first aspect of the present invention, according a second aspect of the present invention, a screw hole for fitting the sub fence is formed on the second guide face.

In the configuration of first and second aspects of the present invention, according to a third aspect of the present invention, the rear face of the sub fence is planarized so as to be in parallel with the guide face.

In addition, it is preferable that a pin is provided on the rear face of the sub fence wherein the pin protrudes rearward, and a bottomed hole corresponding to the pin is provided on the second guide face, so that positioning of the sub fence on the second guide face may be carried out through insertion of the pin into the bottomed hole. It is also preferable that the sub fence is provided with a boss through which a screw to be screwed into the screw hole penetrates, and a opening part of the boss on the guide face is in the shape of a step so that a head of the screw may be embedded in the boss without protruding from the guide face.

To achieve the foregoing objects, according to a ninth aspect of the present invention, a cutting machine includes,

a table, a main body being held on the table in such a manner that the body can move vertically and provided with a rotationally-driven saw blade, and a guide fence to be mounted on the table according to the first aspect of the present invention.

In the first and ninth aspects of the present invention, even a workpiece whose width is beyond the cuttable range can be cut by removal of the sub fence. Further, a workpiece can be surely positioned without any damages even when the sub fence is removed because the second guide face has a plane. At the same time, an adjusting block and the sub fence can be selectively used with ease, thereby assuring ease-of-use.

In addition to the advantageous effects by the first aspect of the present invention, according to the second aspect of the present invention, the adjusting block can be easily fixed to the second guide face using a screw hole.

In addition to the advantageous effects by the first or second aspect of the present invention, the third aspect of the present invention improves dimensional accuracy of the sub fence, thereby obtaining a precise guide face when the sub fence is fixed to the guide section.

### BRIEF DESCRIPTION OF THE DRAWINGS

FIG. 1 is a full view of a flip-over saw.

FIG. 2 is a top view of a flip-over saw.

FIG. 3 is a perspective view of a guide fence as viewed from the front.

FIG. 4 is a perspective view of a guide fence as viewed from the rear.

FIG. 5 is a perspective view of a guide fence as viewed from the front, in which a sub fence is detached.

FIG. 6 is a perspective view of a guide fence as viewed from the rear, in which a sub fence is detached.

FIG. 7 is an explanatory illustration showing the state of cutting with a sub fence (Here, only the part above a table is illustrated).

FIG. 8 is an explanatory illustration showing the state of cutting without a sub fence (Here, only the part above a table is illustrated).

### DETAILED DESCRIPTION OF THE EMBODIMENTS

An exemplary embodiment of the present invention will be described hereinafter with reference to the accompanying drawings.

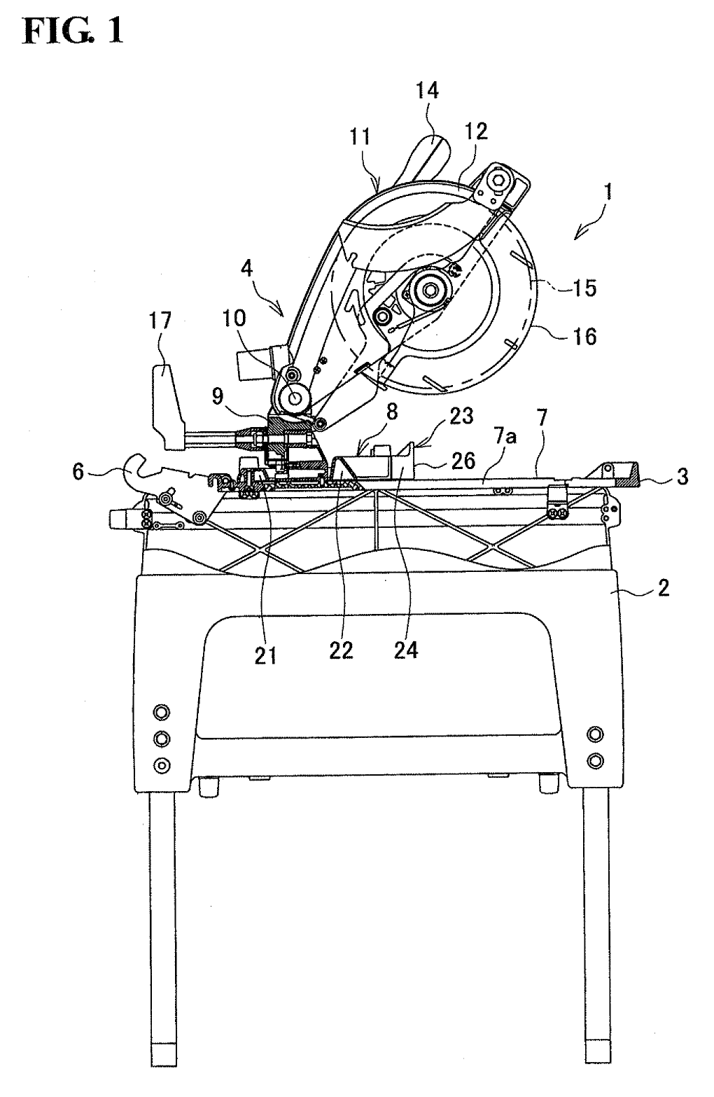

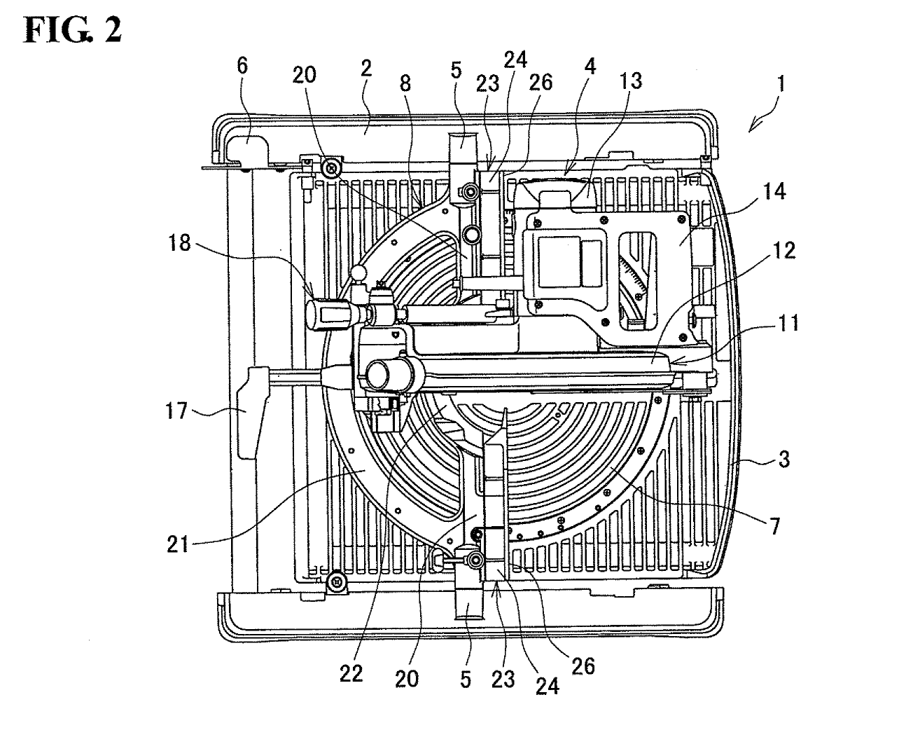

Referring now to FIGS. 1 and 2, a flip-over saw 1 includes a base 2 which is a workbench being rectangular in plan view, a table 3 placed above the base 2, and a saw-blade unit 4 placed on the table 3. The table 3 is supported by rotating shafts 5 extending in the right and left direction (right side in FIGS. 1 and 2 is supposed to be the front.) in such a manner that the table 3 can be flipped over 180° on the shafts 5 and made to be horizontally fixable with either of both sides up by a lock lever 6 disposed on the base 2. Further, a round turntable 7 is disposed on the table 3 in such a manner that the turntable 7 can be rotated horizontally. At the same time, a guide fence 8 is mounted in the right and left direction across over the turntable 7.

The saw-blade unit 4 has a holding arm 9 erected at the rear of the turntable 7 and a main body 11 supported by a pivot 10 at the top end of the holding arm 9 in such a manner that it can move vertically. A motor 13 and a handle 14 are provided in the right side of a blade cover 12 which is a housing for the main body 11, and a disk-like saw blade 15 rotatably driven by the motor 13 is disposed in the blade cover 12. The main body 11 is biased toward the top-dead center in FIG. 1 by a torsion spring (not shown) provided on the pivot 10. When the main body 11 is lowered by pushing of the handle 14 downward so that the saw blade 15 penetrates a slit 7a on the center of the turntable 7 down to the bottom-dead center, a workpiece can be cut on the turntable 7 by the rotation of the saw blade 15. In other words, the saw 1 can be used as a miter saw. Denoted by reference numeral 16 is a safety cover positioned to cover the saw blade 15 at the top-dead center of the main body 11 and then turned to reveal the saw blade 15 as the main body 11 is lowered.

The holding arm 9 is tiltable toward the left on the turntable 7 together with the main body 11, thereby giving the saw blade 15 an angle with respect to the vertical direction by fixing the arm 9 with a lever 17 at any tilting position. With this tilting operation of the main body 11, a bevel cut can be performed on a workpiece on the turntable 7. The turntable 7, in addition, can be turned horizontally together with the main body 11 by swiveling operation of the handle 14. By choosing any horizontal rotation angle of the turntable 7, a right-angle cut in which the saw blade 15 is orthogonal to the guide fence 8, or a miter cut in which the saw blade 15 is tilted sideways can be performed.

On the other hand, the main body 11 can be fixed at the bottom-dead center by a fixing mechanism 18. In the fixed state, when the table 3 is flipped over, the saw 1 can be used as a table saw where cutting operation is performed by sliding a workpiece on the table 3 against the saw blade 15 which protrudes over the table 3.

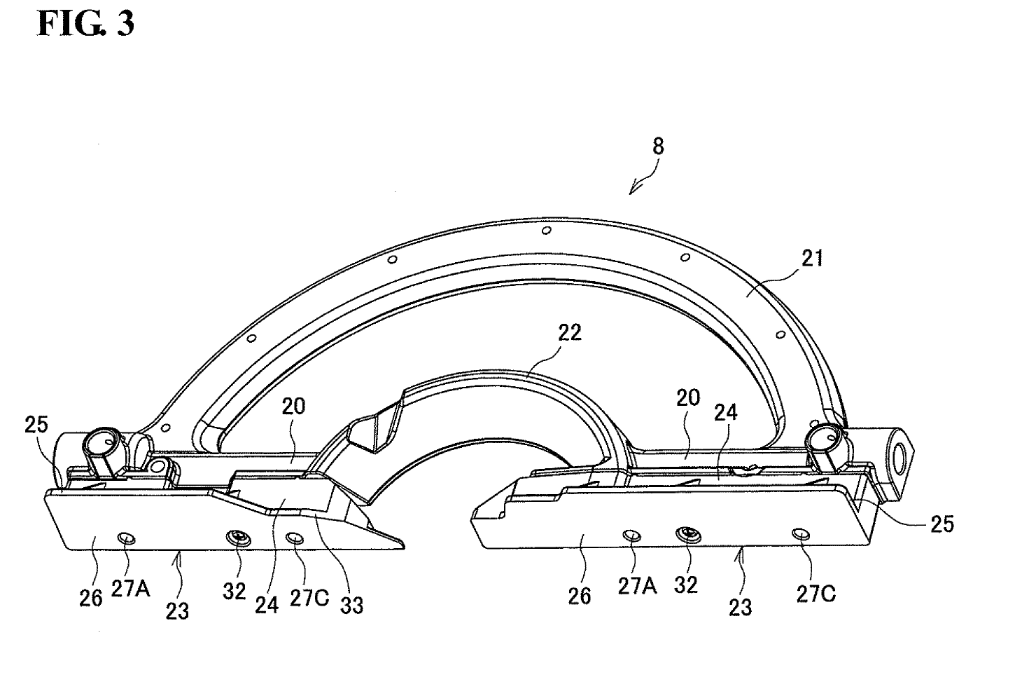

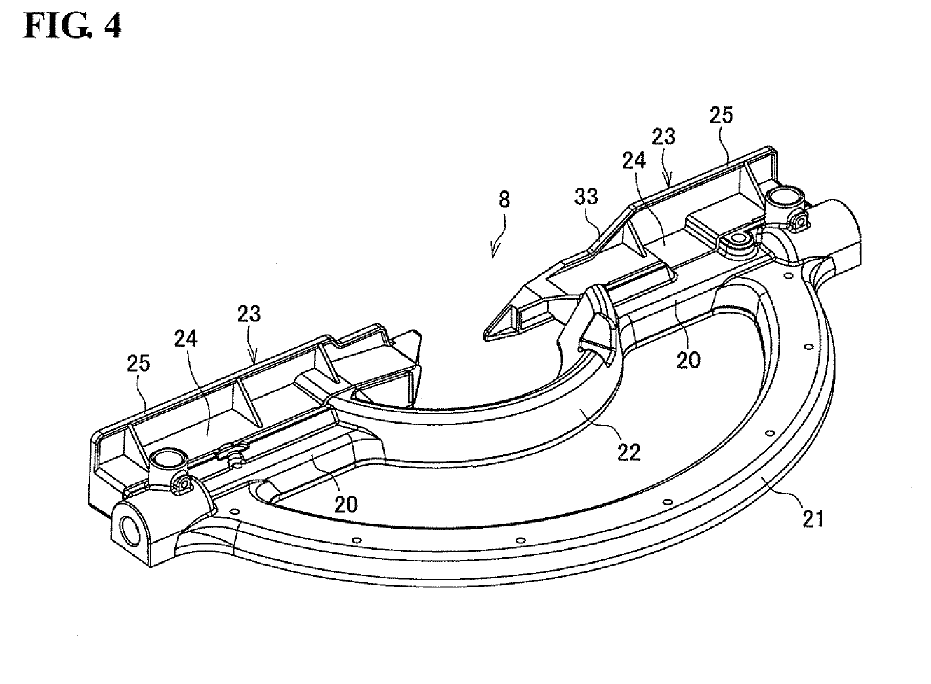

As is illustrated in FIGS. 3 and 4, the guide fence 8 has a pair of right and left guide sections 20 extending in the right and left direction, and large and small coupling frames 21 and 22 of arcuate shape for coupling the guide sections 20 at the rear. While the rotating shafts 5 are respectively held at outer ends of the guide sections 20, the outer coupling frame 21 is fixed on the table 3 by means of screws, and thus the table 3 is rotatably held on the base 2 through the guide fence 8.

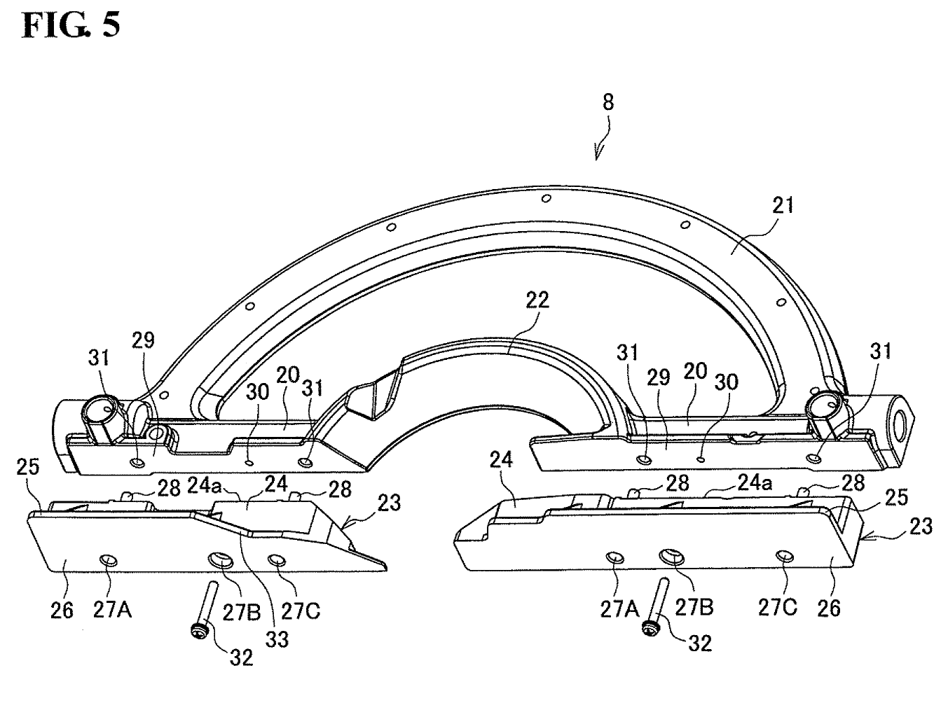

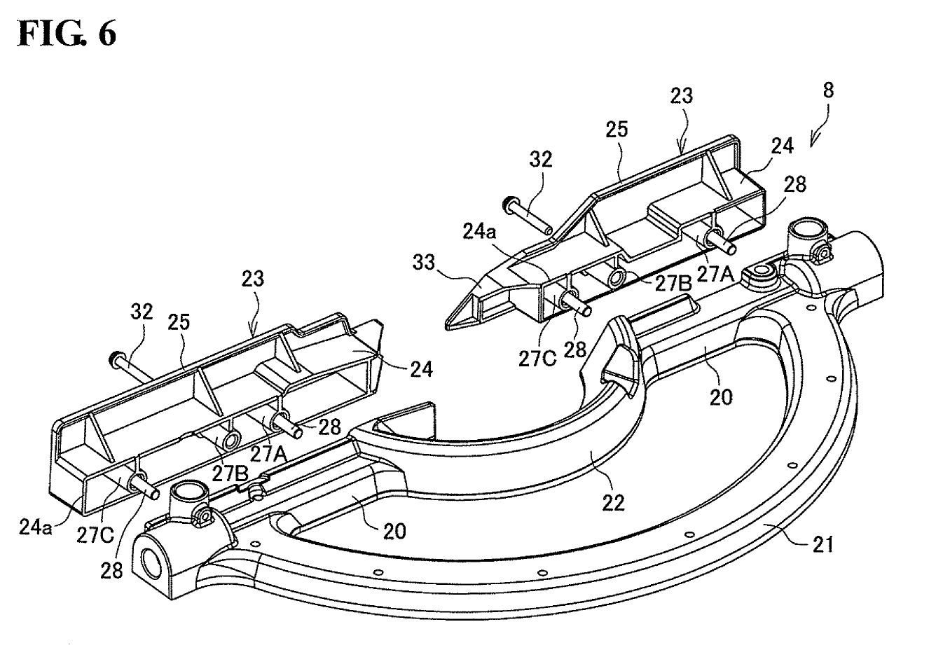

The front part of each guide section 20 is made to be a separate sub fence 23. The sub fence 23 has a box-like block section 24 in the shape of a quadrangle with the longer sides as viewed from the front, and a fence section 25 lying in front of the block section 24. The fence section 25 is higher than the block section 24, and a front face of the fence section 25 serves as a guide face 26 perpendicular to the top face of the turntable 7. As is illustrated in FIGS. 5 and 6, three bosses 27A to 27C are provided on the sub fence 23. The bosses have through holes in the longitudinal direction and are arranged side-by-side in the right and left direction. Among the bosses, the bosses 27A and 27C on both sides in the lateral direction have pins 28 to be pushed into the bosses so as to protrude rearward.

The front face in the rear part of the guide section 20 has a second guide face 29 to which the sub fence 23 is to be fitted. The second guide face 29 has a plane in the shape of a quadrangle with the longer sides and rises upright over the top face of the table 3 and the turntable 7. As for the bottom end of the second guide face 29, while the portion of second guide face 29 facing the top face of the table 3 is in contact with the top face of the table 3, the portion of the second guide face 29 facing the top face of the turntable 7 has slight level difference so that the portion may come near to the top face of the turntable 7. A screw hole 30 and a pair of bottomed holes 31 respectively corresponding to the boss 27B in the center of the sub fence 23 and the right and left pins 28 are provided on the second guide face 29.

The sub fence 23 can be positioned on the second guide face 29 by insertion of the pins 28 into the respective bottomed holes 31 of the second guide face 29. With this positioning, the sub fence 23 can be fixed to the guide section 20 by screwing of a screw 32 into the screw hole 30 on the second guide face 29 from the front of the sub fence 23 through the boss 27B. The opening portion of the boss 27B on the guide face 26 of the sub fence 23 is in a step shape so that the head of the screw 32 may be embedded in the boss 27B without protruding from the guide face 26.

The rear face 24a of the block section 24 is planarized so that the guide face 26 may be in parallel with the second guide face 29 when the sub fence 23 is fitted to the guide section 20. Further, in the state that the sub fence 23 is fitted to the guide section 20, the guide face 26 is flush with the vertical plane passing through the rotational center of the turntable 7 and extending in the right and left direction. The second guide face 29 is in the rearward position retreating from the guide face 26. An escape section 33 sloping down toward the center is provided on a fence section 25 of the left sub fence 23 so as not to interfere with the main body 11 tilted leftward.

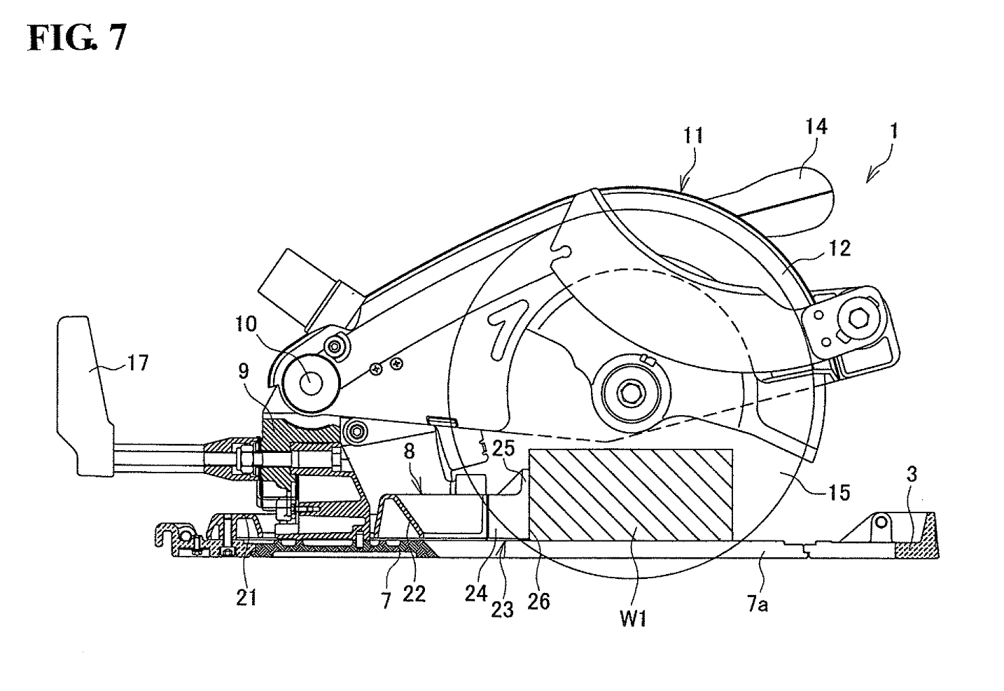

With the flip-over saw 1 configured as described above, when the saw 1 is used as a miter saw with the table 3 in the rotational position as illustrated in FIGS. 1 and 2, the fitted guide fence 8 is used for positioning a workpiece. When a workpiece to be cut is within an ordinary cuttable range, the saw 1 is used with the right and left sub fences 23 respectively fitted to the guide sections 20 as is illustrated in FIGS. 3 and 4. That is, as above, the pins 28 provided in the sub fence 23 are inserted into the bottomed holes 31 on the second guide face 29 and then the sub fence 23 is fitted to the second guide face 29 by means of the screw 32. In this state, as is illustrated in FIG. 7, when a workpiece W1 is pushed against the guide faces 26 in such a manner that the workpiece W1 straddles the right and left guide faces 26 to be positioned. When the main body 11 is lowered so that the saw blade 15 is lowered through the space between the right and left guide faces 26, the workpiece W1 can be cut. The same operation can be done in a bevel cut or a miter cut too.

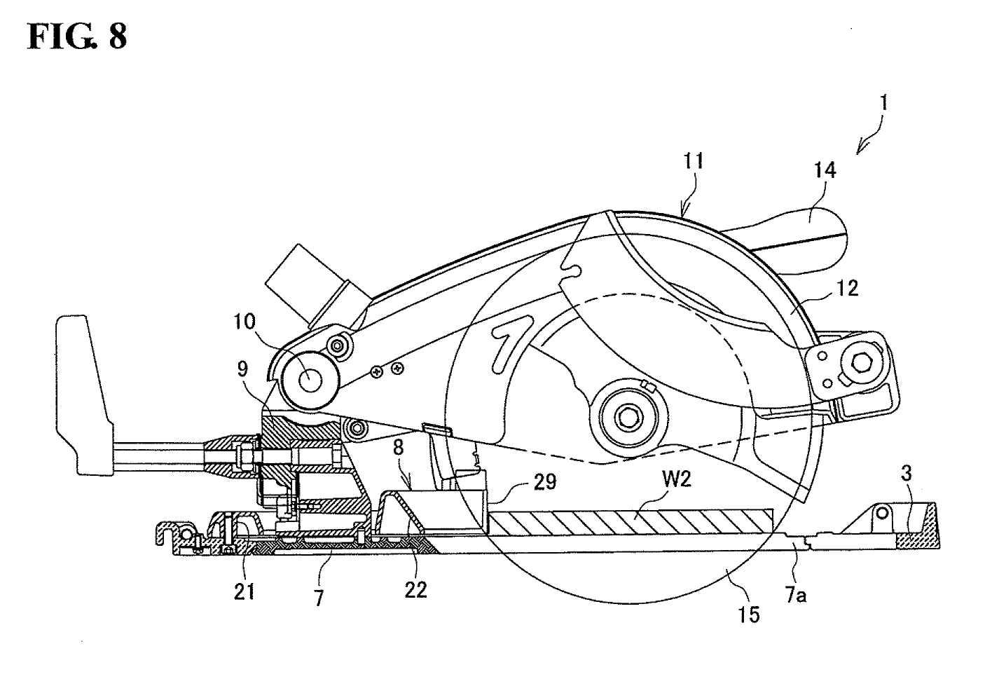

On the other hand, in the case of a thin and wide workpiece being in contact with the guide faces 26, when the main body 11 is lowered down to the bottom-dead-center, the saw blade 15 does not reach the front end of the workpiece. In the case of such workpiece, the saw is used with the sub fences 23 detached from the guide sections 20. The sub fences 23 can be detached from the guide sections 20 by loosening and removing of the screw 32 and then the sub fence 23 is pulled forward to draw the pin 28 out of the bottomed hole 31. In this detached state, as is illustrated in FIG. 8, when the end of a workpiece W2 is brought into contact with the second guide face 29 of the guide section 20 in such a manner that the workpiece W2 extends between the second faces 29. Since the workpiece W2 falls within the cuttable range of the saw blade 15, the workpiece W2 can be cut by lowering of the main body 11. A bevel cut or a miter cut can be performed of course.

An adjusting block for holding a workpiece near the saw blade 15 is often used with a bevel cut. The adjusting block, which has substantially the same height and depth as the sub fences 23 and has been made of waste, can be screwed onto the second guide face 29 by use of the screw hole 30 with the sub fence 23 detached from the guide section 20. This way, the saw 1 can be used by fitting of the adjusting block to the guide section 20 with ease.

As described above, with the flip-over saw 1 and the guide fence 8 according to aforementioned embodiment, the front part of the guide section 20 is made into the separate sub fence 23 provided with the guide face 26. The face of the guide section 20, to which the sub fence 23 is to be fitted, is made into the second guide face 29 in parallel with the guide face 26. The second guide face 29 rises over the top face of a turntable 7 in the rear of the guide face 26. The sub fence 23 is made detachable from the second guide face 29. A workpiece whose width is beyond the cuttable range can be cut by removal of the sub fence 23. Further, a workpiece can be surely positioned without damages even when the sub fence 23 has been removed because the second guide face 29 has a plane. The adjusting block and the sub fence can be selectively used with ease, thereby assuring ease-of-use.

In this embodiment, in particular, a screw hole 30 for fitting the sub fence 23 is provided on the second guide face 29, and thus the adjusting block can be fixed to the second guide face 29 with ease by the screw hole 30.

In addition, the rear face of the sub fence 23 is planarized so that the rear face may be in parallel with the guide face 26. This arrangement improves dimensional accuracy of the sub fence 23, thereby obtaining a precise guide face 26 when the sub fence 23 is fitted to the guide section 20.

It should be noted that the structure of the sub fence is not necessarily limited to the aforementioned embodiment. The sub fence can be formed of a solid material or the number or the position of a screw or a pin can be changed. Further, the screw can be inserted from the rear of the guide section into the sub fence.

As for the way of fitting the sub fence to the guide section, moreover, other structure not using a screw and a pin can be adopted as far as detachable fitting is assured. For example, an engaging section like a hook can be installed on the top end of the fence section for engaging the fence section with the guide section across over the second guide face with the sub fence fitted to the guide section and combine the engaging section with a pin.

It should be also noted that the structure of the guide fence itself is not limited to the aforementioned embodiment. Although right and left guide sections are coupled together by means of a pair of inner and outer coupling frames in aforementioned embodiment, the guide sections can be coupled by means of an inner coupling frame alone. Further, there is no need to provide the guide section with the rotating shaft unless the guide fence is for use in the flip-over saw.

It should be further noted that the structure of a flip-over saw itself is not limited to the aforementioned embodiment. The present invention is applicable even to the structure allowing a main body to tilt toward both the right and the left or the structure having no function of a bevel cut or a miter cut. Needless to say, the present invention is applicable not only to a flip-over saw but also to other cutting machines like bench-circular sawing machines of the type having a main body on a turntable held over a base in such a manner that the turntable can be horizontally rotated, or of the type without a turntable.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A guide fence to be mounted on a table of a cutting machine, the guide fence comprising;
a laterally-extending guide section rising from the top face of the table to have a guide face for positioning a workpiece on front of the guide section;
a separate sub fence detachably disposed in the front part of the guide section having the guide face; and
a second guide face provided on a face of the guide section to which the sub fence is to be fitted, being a plane in parallel with and in the rear of the guide face.

2. The guide fence according to claim 1, wherein a screw hole for fitting the sub fence is formed on the second guide face.

3. The guide fence according to claim 1, wherein the rear face of the sub fence is planarized so as to be in parallel with the guide face.

4. The guide fence according to claim 1, wherein, while a pin is provided to protrude rearward on the rear face of the sub fence, a bottomed hole is provided on the second guide face so that positioning of the sub fence on the second guide face is carried out by insertion of the pin into the bottomed hole.

5. The guide fence according to claim 2, wherein the sub fence is provided with a boss through which a screw to be screwed into the screw hole penetrates, the opening part of the boss on the guide face being in the shape of a step so that the head of the screw is embedded in the boss without protruding from the guide face.

6. The guide fence according to claim 1, wherein an escape section is provided on the sub fence for preventing a main body of the cutting machine from interfering with the sub fence when the main body is tilted.

7. The guide fence according to claim 1, wherein the guide fence has the pair of right and left guide sections and an arcuate coupling frame for coupling the right and left guide sections at rear of the guide section.

8. The guide fence according to claim 1, wherein the sub fence includes a box-like block section in the shape of a quadrangle with the longer skies as viewed from the front and with a depth in the longitudinal direction; and a fence section lying in front of the block section, being made higher than the block section, and whose front face serves as the guide face.

9. A cutting machine comprising;
a table;
a main body held on the table in such a manner that the body can move vertically and provided with a rotationally-driven saw blade; and
a guide fence to be mounted on the table according to claim 1.

10. The cutting machine according to claim 9, wherein a turntable for holding the main body is disposed on the table in such a manner that the turntable can be horizontally rotated, and the guide fence is laterally mounted across over the turntable.

11. The cutting machine according to claim 9, wherein a holding arm is erected at the rear of the table and the main body is supported by a pivot at the top end of the holding arm in such a manner that the main body can move vertically.

12. The guide fence according to claim 2, wherein the rear face of the sub fence is planarized so as to be in parallel with the guide face.
